(19) United States
(12) Patent Application Publication
(10) Pub. No.: US 2008/0088731 A1
(43) Pub. Date: Apr. 17, 2008

(54) Lens Array and Image Sensor Including Lens Array

(76) Inventors: Yasuhiro Tanaka, Hyogo (JP); Michihiro Yamagata, Osaka (JP); Kazutake Boku, Osaka (JP); Hiroaki Okayama, Osaka (JP); Kenichi Hayashi, Nara (JP); Yoshimasa Fushimi, Osaka (JP); Shigeki Murata, Nara (JP); Takayuki Hayashi, Kyoto (JP)

Correspondence Address: MCDERMOTT WILL & EMERY LLP, 600 13TH STREET, NW, WASHINGTON, DC, 20005-3096, US

(21) Appl. No.: 11/795,471

(22) PCT Filed: Dec. 26, 2005
(86) PCT No.: PCT/JP05/23785

§ 371 Date: Jul. 18, 2007

(30) Foreign Application Priority Data
Jan. 20, 2005 (JP) 2005-013351

(51) Int. Cl. H04N 5/225

(52) U.S. Cl. 348/340; 348/E05.024

(57) ABSTRACT

A thin image sensor which is capable of projecting an illuminating light for illuminating an object and has high optical performance is provided. An image sensor (10) includes: a lens array (11) including lens elements (11a) arranged in an array on a plane; an imaging element (13) for converting an optical image into an electrical signal, the imaging element including imaging areas, each of which includes a plurality of photoelectric conversion sections and is operable to receive the optical image; and a light source section (14) for projecting an illuminating light for illuminating an object from which the optical images are to be formed.

### TECHNICAL FIELD

The present invention relates to a lens array and an image sensor including the lens array. Specifically, the present invention relates to a lens array having a plurality of lens elements arranged in an array on a plane and an image sensor including the lens array.

### BACKGROUND ART

As communication networks expand and image processing techniques advance, a need for an image sensor for capturing an image is rapidly growing. Particularly in recent years, the image sensor is included in a portable device (also referred to as a mobile device) such as a mobile phone device and a PDA (Personal Digital Assistant), thereby increasing the number of mobile devices, which improve functions and security thereof.

For example, a system operable to decode information contained in a two-dimensional bar code and the like, captured by the image sensor, and to input information such as a URL (Uniform Resource Locator) on the Internet to the mobile device is in practical use. Further, an image sensor is proposed for a security system using a fingerprint authentication method, which is one of so-called biometrics authentication methods, so as to optically capture a fingerprint in order to input the fingerprint to a device.

In order to capture the aforementioned two-dimensional bar code or the aforementioned fingerprint, a contact image sensor may be used. The contact image sensor as used herein refers to a type of the image sensor which captures an image of an object in approximately the same size while firmly contacting the object. Since the thickness of the contact image sensor in a direction normal to an imaging element (generally, in an optical axis direction) can be reduced, the contact image sensor has an advantage of being incorporated in the mobile device without increasing the thickness of the mobile device.

As an example of the contact image sensor, a fingerprint input device disclosed in Patent Document 1 is proposed. The fingerprint input device disclosed in Patent Document 1 includes a transparent plate having a top surface to be contacted by a finger, a light source for lighting a fingerprint, and an image sensor, and a plurality of spherical lenses are arranged between the transparent plate and the image sensor such that the light from the fingerprint forms an image on the image sensor. According to the fingerprint input device disclosed in Patent Document 1, application of spherical lenses can realize a fingerprint input device including an optical system which is thinner than a conventional optical system and which can be manufactured at low cost.

Patent Document 1: Japanese Laid-Open Patent Publication No. 2004-178487

### DISCLOSURE OF THE INVENTION

### Problems to be Solved by the Invention

In the fingerprint input device disclosed in Patent Document 1, each of the plurality of spherical lenses corresponds to each of the light receiving sections provided on an imaging device. As a result, it is difficult to acquire a high definition image. Further, the fingerprint input device disclosed in Patent Document 1 cannot form an optical image of sufficient quality, due to using spherical lenses.

Objects of the present invention are to provide a thin image sensor which is capable of projecting an illuminating light for illuminating an object and which is capable of acquiring a high resolution image, and to provide a lens array suitable for the image sensor.

### Solution to the Problems

One of the above objects is achieved by an image sensor, which includes a lens array including lens elements arranged in an array on a plane; an imaging element for converting an optical image into an electrical image signal, the imaging element including imaging areas, each of which contains a plurality of photoelectric conversion sections and is operable to receive the optical image; and illuminating means for projecting an illuminating light for illuminating an object from which the optical images are to be formed.

One of the above objects is achieved by a lens array, which includes lens elements arranged in an array on a plane. The lens array is used for an image sensor, which includes the lens array; an imaging element for converting an optical image into an electrical image signal, the imaging element including a plurality of imaging areas, each of which contains a plurality of photoelectric conversion sections and is operable to receive the optical image; and illuminating means including a light guide member which is plate-shaped and made of material capable of transmitting a light, and a light emitting member which is opposed to a side surface of the light guide member. The illuminating means is operable to project, via the lens array, an illuminating light for illuminating an object from which the optical images are to be formed. And, the lens array is formed in an integrated manner with the light guide member.

### EFFECT OF THE INVENTION

According to the present invention, a thin image sensor which is capable of projecting an illuminating light for illuminating an object and has high optical performance, and a lens array suitable for the image sensor can be provided.

### BRIEF DESCRIPTION OF THE DRAWINGS

FIG. 1 is an exploded perspective view showing an image sensor according to an embodiment 1.

FIG. 2 is a cross-sectional view showing the image sensor according to the embodiment 1.

FIG. 3 is a structural diagram showing microstructures formed in a lens array of the image sensor according to the embodiment 1.

FIG. 4 is a partially-transparent perspective view showing the lens array of the image sensor according to the embodiment 1.

FIG. 5 is an exploded perspective view showing an image sensor according to an embodiment 2.

FIG. 6 is a structural diagram showing microstructures formed in a lens array of the image sensor according to the embodiment 2.

FIG. 7 is an enlarged view showing the microstructures formed in the lens array of the image sensor according to the embodiment 2.

FIG. 8 is a cross-sectional view showing an image sensor according to an embodiment 3.

FIG. 9 is a cross-sectional view showing an image sensor according to a variation of the embodiment 3.

FIG. 10 is a cross-sectional view showing an image sensor according to another variation of the embodiment 3.

FIG. 11 is a cross-sectional view showing an image sensor according to an embodiment 4.

FIG. 12A is a diagram showing optical paths of a lens element included in a lens array of an image sensor according to an embodiment 5.

FIG. 12B is a plan view showing formation regions of microstructures formed in the lens array of the image sensor according to the embodiment 5.

FIG. 13 is a perspective view showing a mobile phone according to an embodiment 6.

FIG. 14 is a perspective view showing a structure of a trackball device according to an embodiment 7.

### DESCRIPTION OF THE REFERENCE CHARACTERS

11 lens array
12 dividing wall
13 imaging element
14 light source section
15 reflection plate
16 cold cathode tube
21 lens array
24 light source section
25 LED
31 light guide plate
32 lens array
42 lens array
52 lens array
61 light guide plate
71 object-side plane
72 object light
73 lens array
74 image-side surface
75 light receiving plane
76 footprint of light rays on image-side surface
77 region in which microstructures are formed
81 upper housing
82 lower housing
83 hinge section
84 display device
85 operation button unit
91 housing
92 ball

### BEST MODE FOR CARRYING OUT THE INVENTION

### Embodiment 1

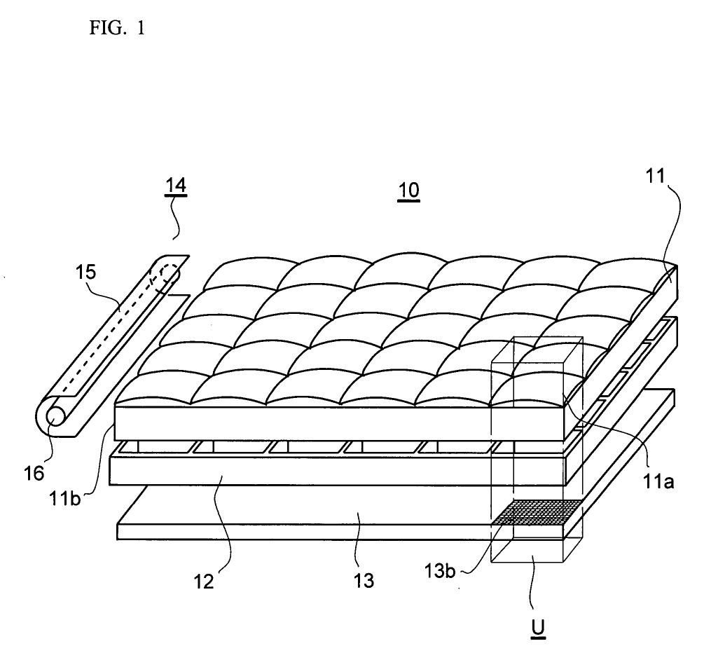

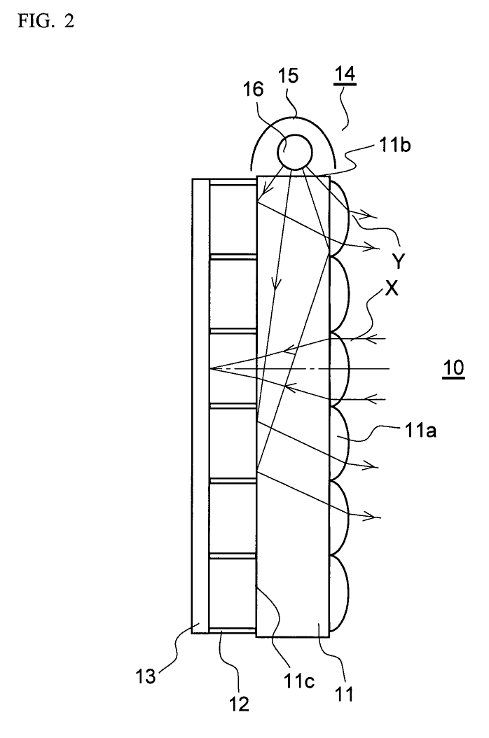

FIG. 1 is an exploded perspective view showing an image sensor according to an embodiment 1. FIG. 2 is a cross-sectional view showing the image sensor according to the embodiment 1. In FIGS. 1 and 2, an image sensor 10 according to the embodiment 1 includes a lens array 11, a dividing wall 12, an imaging element 13, and a light source section 14.

The lens array 11 includes a plurality of lens elements 11a each of which has a convergence power and which are arranged in an array on the same plane. Each of the lens elements 11a functions as an image-forming lens for forming a sectional optical image of an object on the later-described imaging device 13. That is, an object light X is converged on an imaging area by the image-forming lens.

The lens array 11 is made of resin material capable of transmitting a beam of light within a required wavelength region. When the required wavelength region ranges from a visible region to an infrared region, polycarbonate, acrylic resin, polyolefin resin and the like may be used as the resin material of the lens array 11. The lens array 11 is formed such that the plurality of lens elements 11a arranged on an object side are combined in an integrated manner with each other. The plurality of lens elements 11a are arranged such that the optical axes thereof are positioned approximately in parallel to one another. Further, the lens array 11 has a side surface 11b for allowing an illuminating light Y to enter the lens array 11, and has a surface 11c provided on an imaging device 13 side. The surface 11c has microstructures formed thereon for diffracting or scattering the illuminating light Y so as to deflect the illuminating light Y to a side from which the object light X enters the lens array 11. The microstructures will be described below.

The imaging device 13 may typically be a CCD (Charge Coupled Device) and includes a large number of (for example, more than three hundred thousand) photoelectric conversion sections. The imaging device 13 generates an electrical signal corresponding to an optical image formed on a light receiving plane where the photoelectric conversion sections are arranged, and outputs the electrical signal as an image signal. The lens array 11 includes the plurality of lens elements 11a. Thus, each of the plurality of lens elements 11a, each of which corresponds to each of the imaging areas 13a, forms an optical image. Note that each of the imaging areas 13a is set so as to include a plurality of photoelectric conversion sections. That is, the image sensor 10 is a collection of imaging units U each of which includes the lens element 11a and the imaging area 13a provided on the imaging device 13, and therefore is a so-called compound eye imaging apparatus.

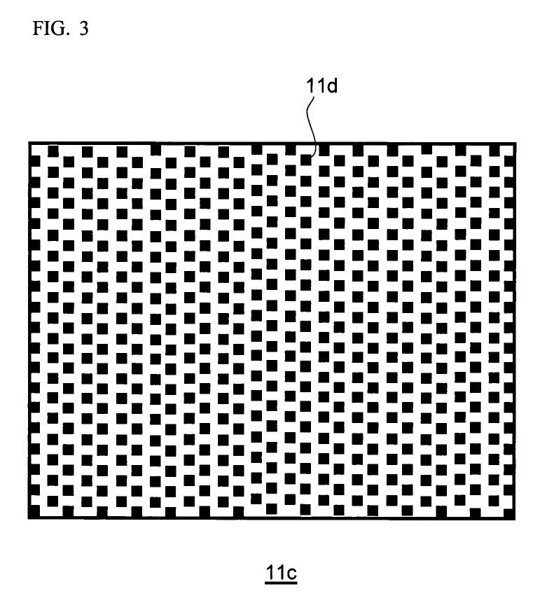

The light source section 14 includes a reflection plate 15 and a cold cathode tube 16. The cold cathode tube 16 is a light emitting member positioned facing the side surface lib of the lens array 11. The reflection plate 15 has an oval-shaped cross-section and reflects a portion of the illuminating light emitted from the cold cathode tube 16 to a lens array 11 side. Further, the microstructures are formed on the surface 11c of the lens array 11, which is opposed to the imaging device 13. FIG. 3 is a structural diagram showing the microstructures formed in the lens array of the image sensor according to the embodiment 1. The microstructures are minute projections, each of which is formed on the surface 11c (on the imaging device 13 side) of the lens array 11 and has a rectangular parallelepiped shape whose width is approximately 10 μm. Minute projections lid, each of which is indicated in black in FIG. 3, are arranged in an array form all over the surface 11c.

In the above-described structure, each of the lens elements 11a forms an optical image of the object, positioned in proximity to each of the lens elements 11a, on the corresponding imaging area 13a. In a case where the image sensor 10 is used as a contact type, each of the lens elements 11a forms the sectional image of the object on the corresponding imaging area 13a. The formed sectional images are outputted as sectional image signals, with respect to each of the imaging units U. The sectional image signals, each of which corresponds to each of the lens elements 11a and is generated by each of the imaging units U, are outputted from the image sensor 10 and are subsequently subjected to image processing such as rotation by a processing device not shown. Then all of the sectional image signals are combined into an image signal.

On the other hand, the illuminating light Y emitted from the cold cathode tube 16 enters the inside of the lens array 11 via the side surface 11b, directly or after reflected by the reflection plate 15. A portion of the illuminating light Y having entered the lens array exits directly therefrom via the plurality of lens elements 11a. Further, another portion of the illuminating light Y having entered the lens array 11 propagates through the lens array 11 while being totally reflected therein.

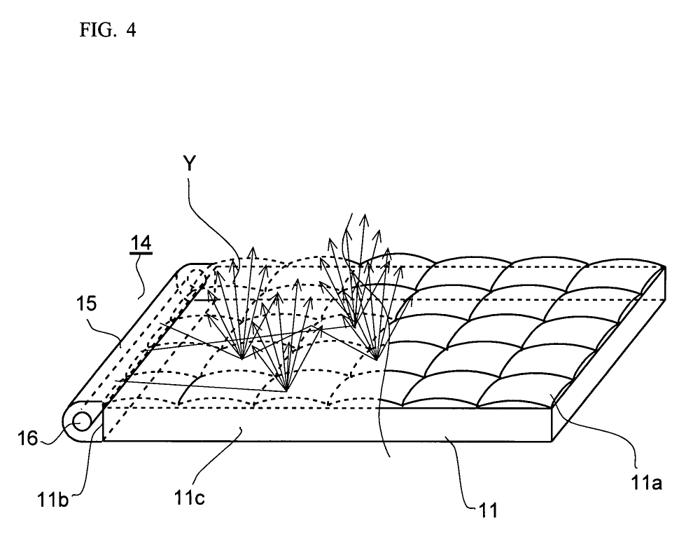

FIG. 4 is a partially-transparent perspective view showing the lens array of the image sensor according to the embodiment 1. The illuminating light Y emitted from the cold cathode tube 16 is diffracted and scattered by the minute projections 11d formed on the surface 11c while propagating through the lens array 11, and then exits from the lens elements 11a. As a result, an illuminating light is projected from the image sensor 10 so as to illuminate the object positioned in proximity to the lens array 11 with a sufficient amount of light. Further, since the microstructures are formed on the surface 11c of the lens array 11, the entire region corresponding to an incident side of the lens array 11 is illuminated.

In this case, the surface 11c of the lens array 11 is positioned so as to be sufficiently defocused from image-forming positions of the lens elements 11a by adjusting the thickness of the lens array 11. The surface 11c of the lens array 11 is positioned in the above-described manner, and therefore, effects on an image caused by the microstructures formed on the surface 11c can be reduced.

As described above, according to the embodiment 1, an object image is acquired by a compound eye optical system. Thus, a contact image sensor which is thin and has high performance can be provided.

Further, according to the embodiment 1, a light can be projected to an object side via a lens element having a convergence power. The entire region corresponding to a lens array can be illuminated with a sufficient amount of light.

Furthermore, according to the embodiment 1, a lens array is formed in an integrated manner with a light guide plate used for projecting an illuminating light. Thus, a contact image sensor having a function of illuminating an object can be provided at low cost without increasing the number of components thereof.

### Embodiment 2

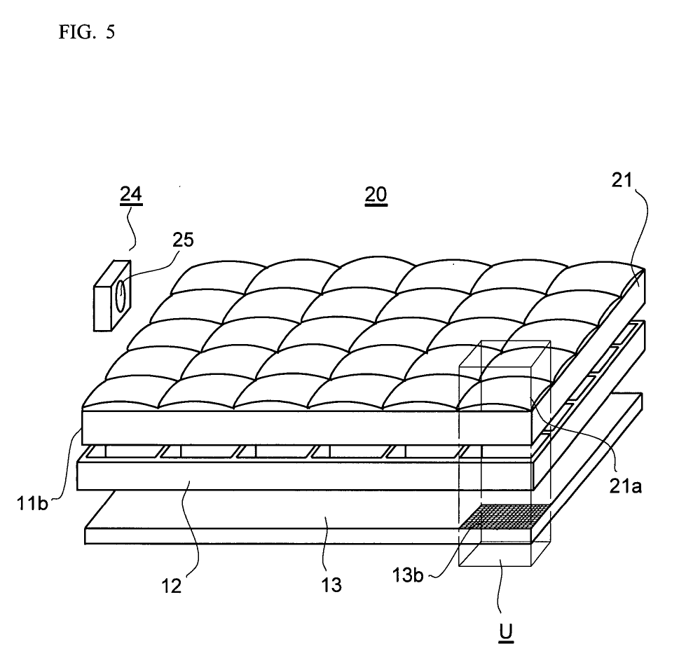

FIG. 5 is an exploded perspective view showing an image sensor according to an embodiment 2. An image sensor 20 according to the embodiment 2 has a structure similar to that of the image sensor 10 according to the embodiment 1. Therefore, in the embodiment 2, the same elements as those of the embodiment 1 will be denoted by the same reference numerals, whereby the description is omitted. And, only differences between the embodiments 1 and 2 will be described below.

The image sensor 20 includes a light source section 24 having a reflection plate 15 and a light emitting diode (LED) 25. The LED 25 is provided facing a portion near an end of a side surface 21b of a lens array 21. The LED 25 serves as a light emitting member for emitting an illuminating light based on a driving voltage supplied from outside. An illuminating light Y emitted from the LED 25 enters the inside of the lens array 21 via the side surface 21b of the lens array 21.

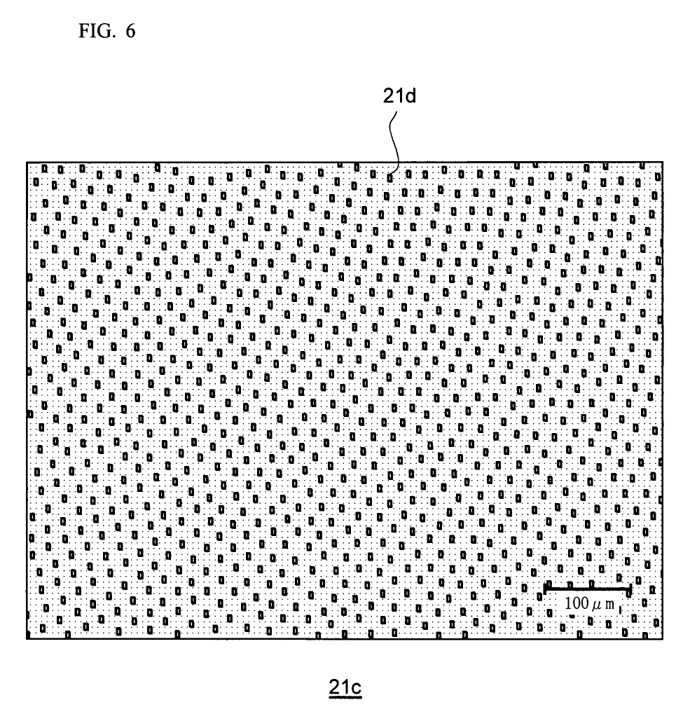

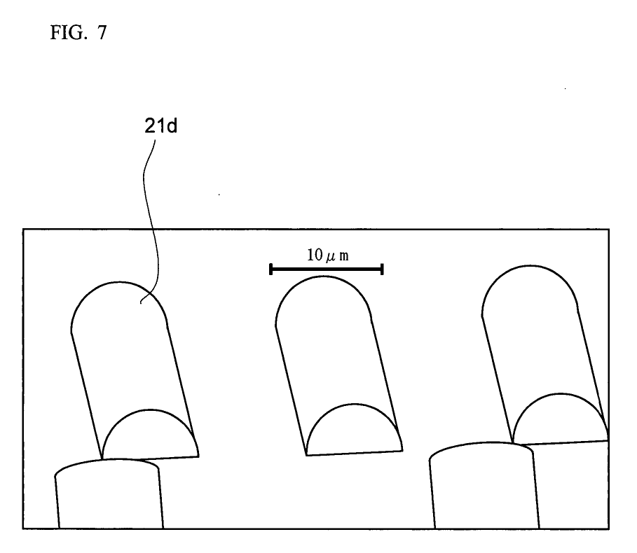

FIG. 6 is a structural diagram showing microstructures formed in the lens array of the image sensor according to the embodiment 2. FIG. 7 is an enlarged view showing the microstructures formed in the lens array of the image sensor according to the embodiment 2.

In FIGS. 6 and 7, the microstructures are minute projections, each of which is formed on a surface 21c (on the imaging device 13 side) of the lens array 21 and has a cylindrical shape. Minute projections 21d are arranged all over the surface 21c in a concentric manner around a light entrance position of the LED 25.

In the above-described structure, the illuminating light Y emitted from the LED 25 enters the inside of the lens array 21 via the side surface 21b in a similar manner to the embodiment 1. A portion of the illuminating light Y having entered the lens array exits directly therefrom via lens elements 21a. Further, another portion of the illuminating light Y having entered the lens array 21 propagates through the lens array 21 while being totally reflected therein.

The illuminating light Y is diffracted and scattered by the minute projections 21d formed on the surface 21c while propagating through the lens array 21, and then exits from the lens elements 21a. As a result, an illuminating light is projected from the image sensor 20 so as to illuminate an object positioned in proximity to the lens array 21 with a sufficient amount of light. Further, since the microstructures are formed on the surface 21c of the lens array 21, the entire region corresponding to an incident side of the lens array 21 is illuminated. Particularly, since an LED is used as a light source of the illuminating light in the image sensor 20, the object can be illuminated with a simple structure.

Further, the surface 21c of the lens array 21 is positioned so as to be sufficiently defocused from image-forming positions of the lens elements 21a by adjusting the thickness of the lens array 21. The surface 21c of the lens array 21 is positioned in the above-described manner, and therefore, effects on an image caused by the microstructures formed on the surface 21c can be reduced.

### Embodiment 3

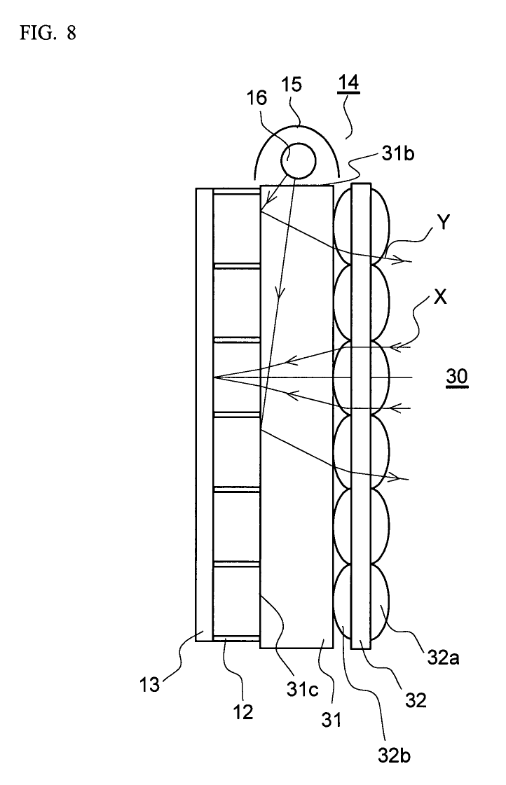

FIG. 8 is a cross-sectional view showing an image sensor according to an embodiment 3. An image sensor 30 according to the embodiment 3 has a structure similar to that of the image sensor 10 according to the embodiment 1. Therefore, in the embodiment 3, the same elements as those of the embodiment 1 will be denoted by the same reference numerals, whereby the description is omitted. And, only differences between the embodiments 1 and 3 will be described below.

The image sensor 30 according to the embodiment 3 is different from the image sensor 10 in that a light guide plate 31 and a lens array 32 are not integrated with each other but are separated from each other. Both of the light guide plate 31 and the lens array 32 are made of resin material capable of transmitting a beam of light within a required wavelength region. When the required wavelength region ranges from a visible region to an infrared region, polycarbonate, acrylic resin, polyolefin resin and the like may be used as the resin material of the light guide plate 31 and the lens array 32. Further, the light guide plate 31 has a side surface 31b for allowing an illuminating light Y to enter the light guide plate 31, and has a surface 31c provided on an imaging device 13 side. The surface 31c has microstructures formed thereon for diffracting and scattering the illuminating light Y so as to deflect the illuminating light Y to a side from which an object light enters the lens array 32 and the light guide plate 31. The microstructures have the same structure as those of the image sensor 10 according to the embodiment 1.

The lens array 32 includes a plurality of optical systems, each of which contains a lens element 32a formed on an object side and a lens element 32b formed on the imaging device 13 side. The plurality of optical systems are formed in an integrated manner with each other, such that the optical axes thereof are positioned approximately in parallel to one another. Each of the optical systems, including the lens element 32a and the lens element 32b, has a convergence power as a whole, and functions as an image-forming lens for forming a sectional optical image of an object on the imaging element 13. That is, an object light X is converged on an imaging area by each of the image-forming lenses.

In the above-described structure, the illuminating light Y enters the inside of the light guide plate 31 via the side surface 31b in a similar manner to the embodiment 1. A portion of the illuminating light Y having entered the light guide plate 31 exits therefrom directly to the object side via the lens elements 32a of the lens array 32. Further, another portion of the illuminating light Y having entered the light guide plate 31 propagates through the light guide plate 31 while being totally reflected therein.

The illuminating light Y is diffracted and scattered by minute projections 31d formed on the surface 31c, and exits from the light guide plate 31 to the object side via the lens elements 32a of the lens array 32. As a result, an illuminating light is projected from the image sensor 30 so as to illuminate the object positioned in proximity to the lens array 32 with a sufficient amount of light. Particularly, a lens array and a light guide plate are separated from each other in the image sensor 30. Thus, an image sensor can be provided at low cost by using a versatile, inexpensive, light guide plate.

Further, the surface 31c of the light guide plate 31 is positioned so as to be sufficiently defocused from image-forming positions of image-forming lens systems including the lens elements 32a and the lens elements 32b by adjusting the thickness of the light guide plate 31 and the lens array 32. The surface 31c of the light guide plate 31 is positioned in the above-described manner, and therefore, effects on an image caused by the microstructures formed on the surface 31c can be reduced.

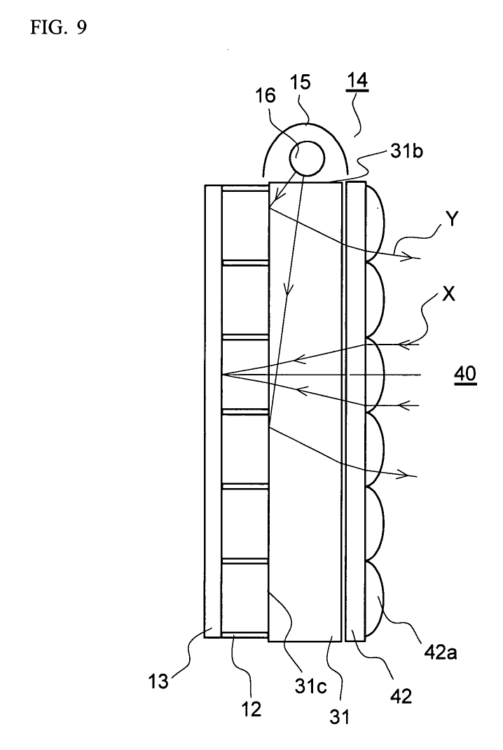

FIG. 9 is a cross-sectional view showing an image sensor according to a variation of the embodiment 3. An image sensor 40 according to the variation of the embodiment 3 includes a light guide plate 31 and a lens array 42. The light guide plate 31 is the same as that included in the image sensor 30. The lens array 42 is different from the lens array 32 included in the image sensor 30 in that lens elements 42a are formed only on an object side. Based on the above-described structure, an imaging apparatus can be provided by using a versatile, inexpensive, light guide plate, and further can be made thinner than the image sensor 30.

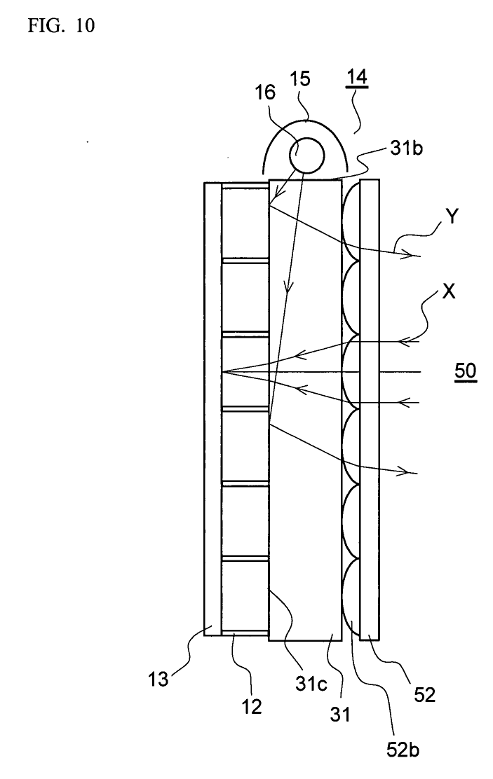

FIG. 10 is a cross-sectional view showing an image sensor according to another variation of the embodiment 3. An image sensor 50 according to said another variation of the embodiment 3 includes a lens array 52. A light guide plate 31 is the same as that included in the image sensor 30. The lens array 52 is different from the lens array 32 included in the image sensor 30 in that lens elements 52a are formed only on an imaging device side. Based on the above-described structure, an imaging apparatus can be provided by using a versatile, inexpensive, light guide plate, and further can be made thinner than the image sensor 30. Further, since an object side of the image sensor 50 can be made flat, the image sensor 50 is suitable especially for a fingerprint input device and the like which has a flat surface portion, preferably, on the object side.

### Embodiment 4

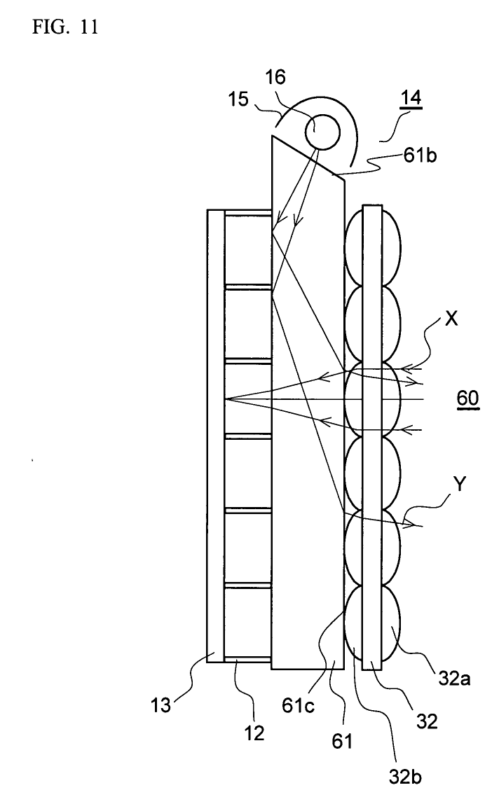

FIG. 11 is a cross-sectional view showing an image sensor according to an embodiment 4. An image sensor 60 according to the embodiment 4 has a structure similar to that of the image sensor 30 according to the embodiment 3. Therefore, in the embodiment 4, the same elements as those of the embodiment 3 will be denoted by the same reference numerals, whereby the description is omitted. And, only differences between the embodiments 3 and 4 will be described below.

The image sensor 60 according to the embodiment 4 is different from the image sensor 30 in that a side surface 61b provided on one side of a light guide plate 61 is inclined toward an optical axis of a lens array 32 in the image sensor 60. In the image sensor 60, a cold cathode tube 16 of a light source section 14 is provided facing the side surface 61b. Further, a surface 61c provided on an object side of the light guide plate 61 has microstructures formed thereon for allowing an illuminating light Y to exit to the object side. The microstructures are minute reflecting prisms each of which has a predetermined periodic structure.

In the above-described structure, the illuminating light Y enters the inside of the light guide plate 61 via the side surface 61b in a similar manner to the embodiment 1. The illuminating light Y having entered the light guide plate 61 propagates through the light guide plate 61 while being totally reflected therein. Further, the illuminating light Y is diffracted and scattered by minute projections formed on the surface 61c, and exits from the light guide plate 61 to the object side via lens elements 32a of the lens array 32. As a result, an illuminating light is projected from the image sensor 60 so as to illuminate an object positioned in proximity to the lens array 32 with a sufficient amount of light. In particular, the inclined surface is formed so as to allow the illuminating light Y to enter a light guide plate in the image sensor 60, and therefore, a large portion of the illuminating light Y can be totally reflected inside the light guide plate. Thus, light use efficiency can be improved.

In the image sensors according to the above embodiments 1 to 4, each of the lens elements is a refractive lens element, but is not limited thereto. Each of the lens elements may be, for example, a diffractive lens element for deflecting a beam of light by diffraction, a gradient-index lens element for deflecting a beam of light by a refractive index profile, or a hybrid element into which the diffractive lens element and the gradient-index lens element are combined.

In the image sensors according to the above embodiments 1 to 4, the light source section is provided for one of the side surfaces of a light guide member, but may not necessarily be positioned in this manner. For example, light source sections may be provided for two side surfaces of the light guide member, or light guide sections may be provided for three or four side surfaces. Further, in the image sensors according to the above embodiments 1 to 4, a reflection member may be provided on side surfaces for which no light source section is provided so as to reflect an entered illuminating light.

In the image sensors according to the above embodiments 1 to 4, the imaging units are completely separated from one another by the dividing wall, but are not limited to this. For example, the distance of the dividing wall in a direction normal to the imaging device may be reduced, or the whole dividing wall may be omitted if crosstalk between the imaging units can be ignored.

In the image sensors according to the above embodiments 1 to 4, all of the lens elements are arranged in a coplanar manner, but are not necessarily be arranged in this manner. For example, all of the lens elements may be arranged on a curved surface. Further, the number of the lens elements is arbitrary, and therefore can be appropriately changed depending on a size or quality of an image to be acquired.

### Embodiment 5

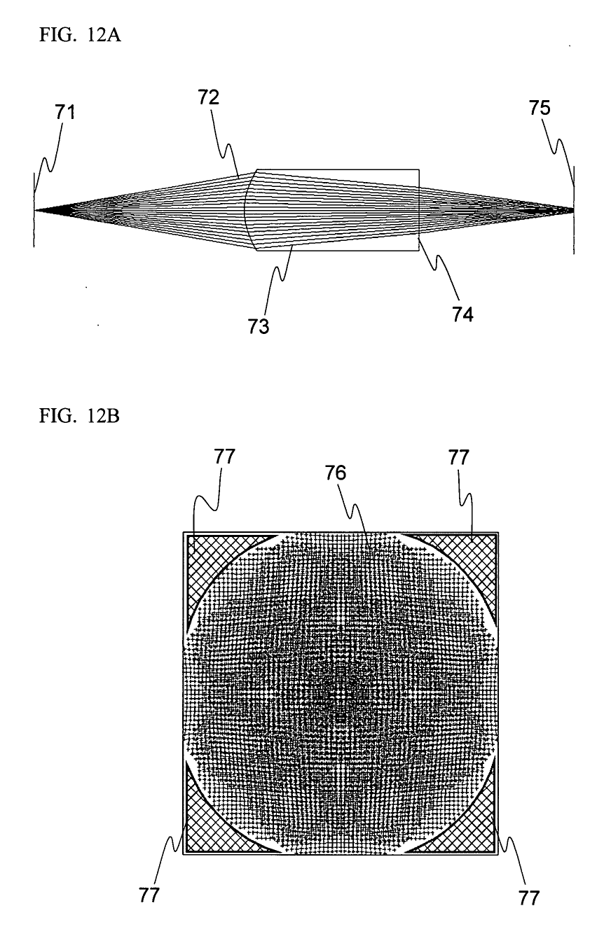

FIG. 12A is a diagram of optical paths of a lens element (only one element is illustrated as a representative example) included in a lens array of an image sensor according to an embodiment 5. FIG. 12B is a plan view showing formation regions of microstructures formed in the lens array of the image sensor according to the embodiment 5. The image sensor according to the embodiment 5 has a structure similar to that of the image sensor 10 according to the embodiment 1. Therefore, only features of the present embodiment will be described below.

In FIG. 12A, an object light 72, which is symmetrical with respect to an optical axis and is emitted from an object-side plane 71 to which an object is attached, enters into a lens array 73 from a lens element side, exits from an image-side surface 74 after converged by the lens element, and is focused on a light receiving plane 75 of an imaging device.

In FIG. 12B, footprints of light rays obtained on the image-side surface 74 are shown in a region 76. Cross marks represent points at which all of light rays contributing to image formation on the light receiving plane 75 intersect with the image-side surface 74. In contrast, regions 77 are formation regions in which microstructures are formed so as to deflect, to the object, an illuminating light directed to the image-side surface 74. The regions 77 do not overlap the region 76. That is, in the image sensor according to the embodiment 5, the microstructures are formed in regions through which effective light related to formation of image does not pass and which are provided on the image-side surface 74 of the lens array. Since the microstructures are formed only in the regions 77 in the above-described manner, an illuminating light can be illuminated without affecting the formation of image, although defocus effect is not considered.

A region, where the effective light rays contributing to image formation do not pass through, may be physically formed by providing a shielding plate for blocking the light rays contributing to the image formation, and then the region is used for each of the regions 77. If the regions 77 are generated in this manner, microstructures, which do not affect image formation, can also be formed on an object-side surface as well as on the image-side surface 74.

In the above-described example, the region 76, through which the effective light rays contributing to image formation do not pass, and the regions 77, in which the microstructures are formed, do not overlap each other at all. However, the region 76 and the regions 77 are not limited to this example. The region 76 and the regions 77 may overlap each other taking into account both of image-forming performance on the light receiving surface and required intensity of an illuminating light. The microstructures may be positioned in any regions where light rays, which are converged by each lens element to form the optical image of an object, do not substantially pass through.

In the above-described examples, as shown in the embodiments 1 and 2, the lens array and a light guide member are formed in an integrated manner, but may not necessarily be formed in this manner. For example, even when the lens array and the light guide member are separated from each other as shown in the embodiments 3 and 4, effects similar to those formed in the integrated manner can be attained by forming the microstructures in the regions through which the effective light rays contributing to image formation do not pass and which are provided on the image-side surface 74 of the lens array.

### Embodiment 6

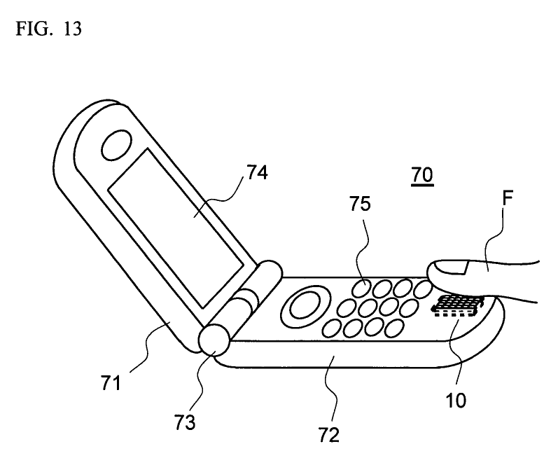

FIG. 13 is a perspective view showing a mobile phone terminal according to an embodiment 6. A mobile phone terminal 80 according to the embodiment 6 includes an upper housing 81, a lower housing 82, a hinge section 83, a display device 84, an operation button unit 85, and the image sensor 10 according to the embodiment 1. The upper housing 81 has the display device 84 including a liquid crystal display device and the like. The lower housing 82 has the operation button unit 85 and the image sensor 10. The upper housing 81 and the lower housing 82 are coupled by the hinge section 83 so as to be openable and closable.

The image sensor 10 functions as a contact type fingerprint input device. That is, when an operator operates a predetermined operation button while causing the operator's finger F to firmly contact the image sensor 10, the image sensor 10 projects an illuminating light for illuminating the finger F and receives a plurality of sectional images corresponding to the surface of the finger F. The image sensor 10 outputs the received sectional images to a processing circuit not shown. An internal image processing circuit in the processing circuit combines sectional images so as to generate a single fingerprint image. The fingerprint image is compared and matched to registered fingerprint images, whereby the operator can be identified.

As described in the embodiment 1, the image sensor 10 can be formed thin, and therefore can be included in a mobile device such as a mobile phone terminal without increasing the thickness of the device. Further, the image sensor 10, which is a compound eye imaging apparatus, can output a high precision image signal, and therefore can acquire a sufficiently high resolution image even when used for a fingerprint input device.

Note that it is to be understood that the above-described image sensors 20, 30, 40, 50, 60, and the like may be used in place of the image sensor 10.

### Embodiment 7

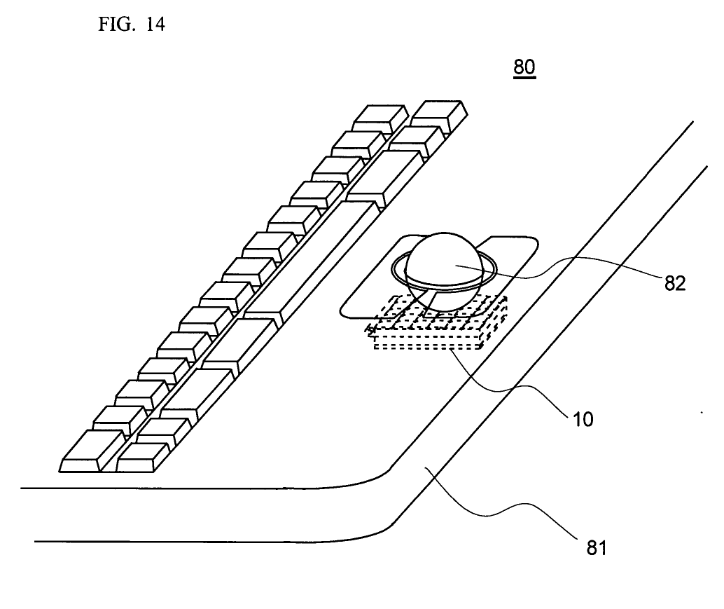

FIG. 14 is a perspective view showing a structure of a trackball device according to an embodiment 7. A trackball device 90 according to the embodiment 7 is incorporated in a laptop personal computer. The trackball device 90 is built in a housing 91 of the personal computer and includes a ball 92 and the image sensor 10. The ball 92 is supported such that an approximate hemisphere thereof is exposed from the housing 91, so as to be used as a user interface. The image sensor 10 is positioned within the housing 91 and under the ball 92.

On the surface of the ball 92, minute detection patterns not shown are formed. When an operator rotates the ball 92, the image sensor 10 converts movement of the detection patterns formed on the ball 92 into an image signal and outputs the image signal to a processing circuit not shown. Based on the image signal, the processing circuit detects direction, distance, speed, and the like of the rotation of the ball 92. The detected information relating to the ball 92 is used for controlling the personal computer.

As described in the embodiment 1, the image sensor 10 can be formed thin, and therefore can be included in a trackball device without increasing the thickness of the trackball device. Further, the image sensor 10 which is a compound eye imaging apparatus can output a high precision image signal, and therefore can acquire a sufficiently high resolution image even when used for a trackball device.

Note that it is to be understood that the above-described image sensors 20, 30, 40, 50, 60, and the like may be used in place of the image sensor 10.

### Other Embodiments

Note that each of the above embodiments is described as applied to a contact image sensor. However, each of the above embodiments can also be applied to and is useful as means for providing an illuminating light even in a case where there is a distance between an image sensor and an object.

### INDUSTRIAL APPLICABILITY

The present invention is suitable for an image sensor for inputting information contained in an image such as a two-dimensional bar code and biometrics information such as a fingerprint. Further, the present invention is suitable for a position sensor for detecting displacement of a trackball used for an interface of a personal computer and the like.

1. An image sensor comprising:
a lens array including lens elements arranged in an array on a plane;
an imaging element for converting an optical image into an electrical image signal, the imaging element including imaging areas, each of which contains a plurality of photoelectric conversion sections and is operable to receive the optical image; and
an illuminating unit for projecting, via the lens array, an illuminating light for illuminating an object from which the optical images are to be formed.

2. The image sensor according to claim 1, wherein the illuminating unit includes:
a light guide member which is plate-shaped and made of material capable of transmitting a light; and
a light emitting member which is opposed to a side surface of the light guide member.

3. The image sensor according to claim 2, wherein the light guide member is formed in an integrated manner with the lens array.

4. The image sensor according to claim 2, wherein the light guide member is separated from the lens array.

5. The image sensor according to claim 2, wherein the light guide member has microstructures for deflecting the illuminating light toward the object.

6. The image sensor according to claim 5, wherein the microstructures are provided in a region where light rays, which are converged by the optical system including the lens elements to form the optical images of the object, do not substantially pass through.

7. A lens array including lens elements arranged in an array on a plane, wherein
the lens array is used for an image sensor, the image sensor comprising:
the lens array;
an imaging element for converting an optical image into an electrical image signal, the imaging element including a plurality of imaging areas, each of which contains a plurality of photoelectric conversion sections and is operable to receive the optical image; and
an illuminating unit including a light guide member which is plate-shaped and made of material capable of transmitting a light, and a light emitting member which is opposed to a side surface of the light guide member, the illuminating unit being operable to project an illuminating light for illuminating an object from which the optical images are to be formed, and
the lens array is formed in an integrated manner with the light guide member.
